(19) United States
(12) Patent Application Publication
(10) Pub. No.: US 2004/0014925 A1
(43) Pub. Date: Jan. 22, 2004

(54) Process for preparing organomodified polysiloxanes using ionic liquids

(76) Inventors: Kerstin Hell, Essen, DE (US); Bernd Weyershausen, Essen (DE); Ute Hesse, Essen (DE)

Correspondence Address: FROMMER LAWRENCE & HAUG LLP, 745 Fifth Avenue, New York, NY, 10151, US

(21) Appl. No.: 10/619,395

(22) Filed: Jul. 15, 2003

(30) Foreign Application Priority Data
Jul. 17, 2002 (DE) 102 32 305.4

(51) Int. Cl. C08G 77/12

(52) U.S. Cl. 528/31

(57) ABSTRACT

The invention relates to a process for preparing organomodified polysiloxanes by addition of SiH-containing polysiloxanes onto substances containing C—C multiple bonds in the presence of transition metal catalysts, in which

a) the reaction is carried out in the presence of an ionic liquid and

b) after the reaction is complete, the ionic liquid together with the dissolved catalyst is separated from the reaction mixture.

### RELATED APPLICATIONS

This application claims priority to German application 102 35 305.4, filed Jul. 17,2002, herein incorporated by reference.

### BACKGROUND OF THE INVENTION

1. Field of the Invention

The invention relates to a process for preparing organomodified polysiloxanes by addition of SiH-containing polysiloxanes onto substances containing C—C multiple bonds in the presence of transition metal catalysts and of ionic liquids, so that the transition metal catalysts can be reused directly for subsequent catalysis cycles.

1. Description of the Related Art

Among processes for producing and for modifying organopolysiloxanes, hydrosilylation in the presence of transition metal catalysts is of particular importance since it permits a variety of SiC linkages. However, although this reaction has wide applicability, its industrial implementation is often accompanied by considerable difficulties.

One problem is the changing catalyst activity over time and its susceptibility to disturbances.

Another disadvantage of hydrosilylation in the presence of transition metal catalysts as described in the prior art (cf Bogdan Marcniec in “Applied Homogeneous Catalysis with Organometallic Compounds”, Volume 1, Eds: Boy Cornils, Wolfgang A. Herrmann, V C H, Weinheim, 1996, pp. 487494) is that the catalyst generally remains in the product or can be removed from the products only at considerable expense (costs for extraction of the catalyst).

In homogeneous catalysis, removal or immobilization and in particular direct reuse of the catalyst generally presents a great problem for both economic and ecological reasons. This in turn has led to efforts to keep the amount of catalyst used as small as possible, but this results in relatively long reaction times.

In view of the above, industrial use is economically viable only when catalyst losses can be kept very small and acceptable reaction times can be achieved.

There is therefore a need for processes which make it possible to recycle the catalyst a) virtually without losses and b) with imposition of the lowest possible stress on the product.

Intensive work has therefore been carried out in the past on “heterogenizing”, “immobilizing” and “anchoring” homogeneous catalysts to simplify separation of the catalyst from the products and recovery of the catalyst (for a general review, see “Applied Homogeneous Catalysis with Organometallic Compounds”, Volume 2, Eds: Boy Cornils, Wolfgang A. Herrmannm, V C H, Weinheim, 1996, pp. 573-623). For work on the immobilization of transition metal complexes for use in the hydrosilylation reaction, see: Bogdan Marcniec in “Applied Homogeneous Catalysis with Organometallic Compounds”, Volume 1, Eds: Boy Cornils, Wolfgang A. Herrmann, V C H, Weinheim, 1996, pp. 494-496, and references cited therein.

Apart from, for example, extraction of the catalysts or their adsorption on ion exchangers, a multiphase reaction is a further possible way of separating product and catalyst phases. Here, the limited miscibility of the product phase with the catalyst phase is exploited to achieve the separation.

In recent years, the two-phase reaction using ionic liquids has steadily increased in importance. In all known examples, the ionic liquid forms the phase in which the catalyst is present as a solution.

The term “ionic liquids” refers to salts which melt at low temperatures (<100° C.) and represent a new class of solvents having non-molecular, ionic character. In contrast to classical salt melts, which are high-melting, highly viscous and very corrosive media, ionic liquids are liquid and have relatively low viscosity even at low temperatures (K. R. Seddon J. Chem. Technol. Biotechnol. 1997,68,351-356).

In most cases, ionic liquids consist of anions such as halides, carboxylates, phosphates, sulfates, sulfonates, tetrafluoroborates or hexafluorophosphates combined with substituted ammonium, phosphonium, pyridinium or imidazolium cations.

Ionic liquids form two phases with many organic product mixtures, thus providing the opportunity of carrying out the reaction in a multiphase system to enable homogeneous catalysts to be separated off. A general overview of this subject may be found, for example, in T. Welton Chem. Rev. 1999,99,2071-2083; J. D. Holbrey, K. R. Seddon Clean Products and Processes 1999, 1, 223-236; P. Wasserscheid, W. Keim Angew. Chem. 2000,112, 3926-3945 and R. Sheldon Chem. Commun. 2001,2399-2407.

Some publications describe a multiphase reaction to enable homogeneous catalysts to be separated off more easily: for example the hydrogenation of olefins using rhodium(I) (R. F. de Souza et al. Polyhedron 1996, 15, 1217-1219) or hydroformylation reactions (Y. Chauvin et al. Angew. Chem. 1995, 107, 2941-2943. N. Karodia et al. Chem. Commun. 1998, 2341-2342). In all these examples, the product separation is achieved by phase separation.

This method sometimes has the disadvantage that the standard catalysts used, for example the Wilkinson catalyst [(Ph₃P)₃Rh(I)Cl] used by Chauvin (Angew. Chem. 1995, 107, 2941-2943), do not remain entirely in the polar ionic liquid (organic hexafluorophosphate, tetrafluoroborate) but also diffuse into the product phase (catalyst leaching). A remedy is to modify the catalyst so that all of it remains in the ionic liquid. This can be achieved, for example, by replacing the triphenylphosphane ligand by the sodium salts of monosulphonated and trisulfonated triphenylphosphane, but in this case the catalytic activity falls drastically.

### OBJECT OF THE INVENTION

It is therefore an object of the present invention, inter alia, to provide a process which makes it possible for the hydrosilylation catalyst to be recycled in a simple fashion in the preparation of organomodified polysiloxanes. These and other objects will be apparent from the following description of the invention.

### DESCRIPTION OF THE INVENTION

It has surprisingly been found that the substances containing C—C multiple bonds can be hydrosilylated by (Si—H)-functional polysiloxanes using a catalyst phase comprising a suitable combination of a standard hydrosilylation catalyst with an ionic liquid. After the reaction is complete, the catalyst phase can be separated from the product phase by simple phase separation (decanting off the product phase or filtration) and be reused directly without a loss of activity.

Surprisingly, no catalyst leaching occurs here even when using standard catalysts, so that a metal-flee product is obtained. As a result, modification of the ligands to prevent leaching, as in the hydrogenation reactions described by Chauvin (Angew. Chem. 1995, 107, 2941-2943) can be dispensed with. Furthermore, it has surprisingly been found that the ionic liquid has a stabilizing influence on the activity of the transition metal catalyst, since this is not adversely affected even on multiple reuse of the catalyst, but instead remains constant.

The invention accordingly provides a process for preparing organomodified polysiloxanes by addition of SiH-containing polysiloxanes onto substances containing C—C multiple bonds in the presence of transition metal catalysts, wherein

a) the reaction is carried out in the presence of an ionic liquid and

b) after the reaction is complete, the ionic liquid together with the dissolved catalyst is separated from the reaction mixture.

It is also possible to add an ionic liquid to the reaction mixture after a standard hydrosilylation reaction which has been carried out as described in the prior art. In the first case (addition of the ionic liquid to the reaction mixture prior to or during the hydrosilylation reaction), the catalyst phase according to the invention is formed in situ, while addition of an ionic liquid to the reaction mixture from a standard hydrosilylation reaction, i.e. after the reaction has proceeded to completion (100% SiH conversion), is equivalent to extraction of the catalyst from the reaction mixture or from the product phase.

The invention therefore also provides a process for the extraction of the catalysts used in the standard hydrosilylation reaction, in which an ionic liquid added to the reaction mixture after the reaction is complete is used as extractant.

In all cases, the addition of the ionic liquid generates a catalyst phase in which the hydrosilylation catalyst is present as a homogeneous solution and which can be separated off from the product phase by simple decantation or filtration without catalyst losses. This catalyst phase can be reused in further hydrosilylation reactions without further after-treatment, with no loss of activity of the hydrosilylation catalyst occurring. The process of the invention thus makes it possible for the expensive noble metal catalyst to be recycled without problems.

The invention therefore also provides a process for carrying out standard hydrosilylation reactions, in which a recycled mixture of catalyst and ionic liquid is added to the reaction m

### DETAILED DESCRIPTION OF THE INVENTION

The process of the invention for preparing organomodified polysiloxanes by addition of SiH-containing polysiloxanes onto substances containing C—C multiple bonds in the presence of transition metal catalysts and of ionic liquids, so that the transition metal catalysts can be reused directly for subsequent catalysis cycles, is characterized in that an ionic liquid which is composed of at least one quaternary nitrogen and/or phosphorus compound and at least one anion and has a melting point below about +250° C., preferably below about +150° C., in particular below about +90° C., is added to the reaction mixture.

Ionic liquids which are preferably used in the process of the invention comprise at least one cation of the formulae:

R¹R²R³R⁴N^{⊕} (1)

R¹R²N⁶¹ ═CR³R⁴ (2)

R¹R²R³R⁴P^{⊕} (3)

R¹R²P^{⊕}═CR³R⁴ (4)

where

R¹,R²,R³,R⁴ are identical or different and are each hydrogen, a linear or branched aliphatic hydrocarbon radical, preferably having from 1 to 20 carbon atoms, a cycloaliphatic hydrocarbon radical, preferably having from 5 to 30 carbon atoms, an aromatic hydrocarbon radical, preferably having from 6 to 30 carbon atoms, an alkylaryl radical, preferably having from 7 to 40 carbon atoms, a linear or branched aliphatic hydrocarbon radical which preferably has from 2 to 20 carbon atoms and is interrupted by one or more hetero atoms (oxygen, NH, NR′ where R′ is a C₁-C₅-alkyl radical, in particular —CH₃), a linear or branched aliphatic hydrocarbon radical preferably which has from 2 to 20 carbon atoms and is interrupted by one or more functional groups selected from among —O—C(O)—, —(O)C—O—, —NH—C(O)—, —(O)C—NH, —(CH₃)N—C(O)—, —(O)C—N(CH₃), —S(O₂)—O—, —O—S(O₂)—, —S(O₂)—NH—, —NH—S(O₂)—, —S(O₂)—, —N(CH₃)—, —N(CH₃)—S(O₂)—, a linear or branched aliphatic hydrocarbon radical, preferably which has from 1 to 20 carbon atoms and is functionalized at the end of the chain by OH, NH₂, N(H)R′ where R′ is a C₁-C₅-alkyl radical, or a polyether which may have a block or random structure and has the formula —(R⁵—O)ₙ—R⁶,

where

R⁵ is a linear or branched hydrocarbon radical, preferably containing from 2 to 4 carbon atoms,

n is from 1 to 30, preferably from 2 to 15, and

R⁶ is hydrogen, a linear or branched aliphatic hydrocarbon radical, preferably having from 1 to 20 carbon atoms, a cycloaliphatic hydrocarbon radical having from 5 to 30 carbon atoms, an aromatic hydrocarbon radical, preferably having from 6 to 30 carbon atoms, an alkylaryl radical preferably having 7 to 40 carbon atoms or a —C(O)—R⁷ radical where

R⁷ is a linear or branched aliphatic hydrocarbon radical, preferably having from 1 to 20 carbon atoms, a cycloaliphatic hydrocarbon radical, preferably having from 5 to 30 carbon atoms, an aromatic hydrocarbon radical preferably having from 6 to 30 carbon atoms or an alkylaryl radical preferably having from 7 to 40 carbon atoms.

Further suitable cations are cations derived from saturated or unsaturated cyclic compounds and from aromatic compounds each having at least one trivalent nitrogen atom in a four- to ten-membered, preferably five- or six-membered, heterocyclic ring which may be substituted. Such cations can be represented in simplified form (i.e. without the precise position and number of double bonds in the molecule being specified) by the formulae (5), (6) and (7) below, in which the heterocyclic rings may also contain further heteroatoms.

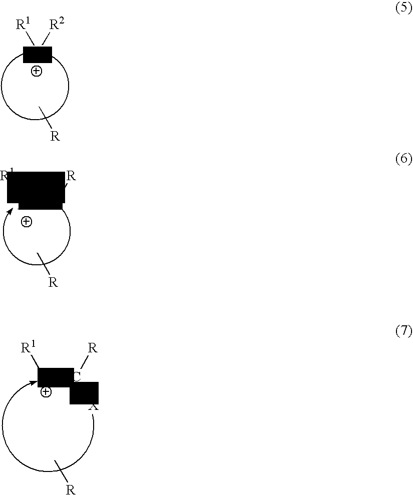

R¹ and R² are as defined above.

R is a hydrogen atom, a linear or branched aliphatic hydrocarbon radical preferably having from 1 to 20 carbon atoms, a cycloaliphatic hydrocarbon radical preferably having from 5 to 30 carbon atoms, an aromatic hydrocarbon radical preferably having from 6 to 30 carbon atoms or an alkylaryl radical preferably having from 7 to 40 carbon atoms. Examples of cyclic nitrogen compounds of the abovementioned type are pyrrolidine, dihydropyrrole, pyrrole, oxazoline, oxazole, thiazoline, thiazole, isoxazole, isothiazole, indole, carbazole, piperidine, pyridine, the isomeric picolines and lutidines, quinoline and isoquinoline. The cyclic nitrogen compounds of the formulae (5), (6) and (7) may be unsubstituted (R═H) or monosubstituted or polysubstituted by the radical R.

X is an oxygen atom, a sulfur atom or a substituted nitrogen atom (X═O, S, NR).

Further possible cations are cations derived from saturated acyclic compounds, saturated or unsaturated cyclic compounds or aromatic compounds each having more than one trivalent nitrogen atom in a 4- to 10-membered preferably 5- or 6-membered, heterocyclic ring. These compounds may be substituted on the carbon atoms and/or the nitrogen atoms, preferably by alkyl radicals having from 1 to 10 carbon atoms or by phenyl radicals. Furthermore, they can be fused with substituted or unsubstituted benzene rings or cyclohexane rings to form polycyclic structures. Examples of such compounds are pyrazole, 3,5-dimethylpyrazole, imidazole, benzimidazole, N-methylimidazole, dihydropyrazole, pyrazolidine, pyridazine, pyrimidine, pyrazine, pyridazine, pyrimidine, 2,3-, 2,5- and 2,6-dimethylpyrazine, cimoline, phthalazine, quinazoline, phenazine and piperazine. Cations of the formula (8) derived from imidazole and its alkyl and phenyl derivatives have been found to be particularly useful as constituents of the ionic liquid.

Further suitable cations are ions which contain two nitrogen atoms and have the formula (8),

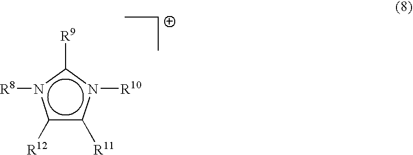

where

R⁸,R⁹,R¹⁰,R¹¹,R¹² are identical or different and are each hydrogen, a linear or branched aliphatic hydrocarbon radical preferably having from 1 to 30 carbon atoms, a cycloaliphatic hydrocarbon radical preferably having from 5 to 30 carbon atoms, an aromatic hydrocarbon radical preferably having from 6 to 30 carbon atoms, an alkylaryl radical preferably having from 7 to 40 carbon atoms, a linear or branched aliphatic hydrocarbon radical preferably having from 1 to 20 carbon atoms, which is interrupted by one or more hetero atoms (oxygen, NH, NR′ where R′ is a C₁-C₅-alkyl radical), a linear or branched aliphatic hydrocarbon radical, preferably having from 1 to 20 carbon atoms and which is interrupted by one or more functional groups selected from among —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic hydrocarbon radical, preferably from 1 to 20 carbon atoms and is functionalized at the end of the chain by OH, NH₂, N(H)R′ where R′ is a C₁-C₅-alkyl radical, or a polyether which may have a block or random structure and has the formula —(R—O)ₙ—R⁶,

where

R⁵ is a hydrocarbon radical, preferably containing from 2 to 4 carbon atoms,

n is from 1 to 30 and

R⁶ is hydrogen, a linear or branched aliphatic hydrocarbon radical, preferably having form 1 to 20 carbon atoms, a cycloaliphatic hydrocarbon radical preferably having from 5 to 30 carbon atoms, an aromatic hydrocarbon radical preferably having from 6 to 30 carbon atoms, an alkylaryl radical preferably having 7 to 40 carbon atoms or a —C(O)—R⁷ radical where

R⁷ is a linear or branched aliphatic hydrocarbon radical preferably having from 1 to 20 carbon atoms, a cycloaliphatic hydrocarbon radical preferably having from 5 to 30 carbon atoms, an aromatic hydrocarbon radical, preferably having from 6 to 30 carbon atoms or an alkylaryl radical, preferably having from 7 to 40 carbon atoms.

The ionic liquids which are preferably used in the process of the invention comprise at least one of the abovementioned cations combined with, in each case, an anion. Preferred anions are selected from the group consisting of, without making any claims as to completeness, halides, bis(perfluoroalkylsulfonyl)amides, alkyltosylates and aryltosylates, perfluoroalkyltosylates, nitrates, sulfates, hydrogensulfates, alkylsulfates and arylsulfates, perfluoroalkylsulfates, sulfonates, alkylsulfonates and arylsulfonates, perfluorinated alkylsulfonates and arylsulfonates, alkylcarboxylates and arylcarboxylates, perfluoroalkylcarboxylates, perchlorates, tetrachloroaluminates, saccharinates. Further preferred anions are dicyanamide, tetrafluoroborate, hexafluorophosphate and phosphate.

The ionic liquid is modified by variation of the cation and the anion so that the ionic liquid is immiscible with the product phase but the catalyst is soluble in the ionic liquid and insoluble in the product phase.

The amount of ionic liquid added is in the range from about 0.1 to about 98% by mass, preferably from about 0.1 to about 20% by mass, particularly preferably from about 0.5 to about 5% by mass, based on the mass of the heterogeneous reaction mixture.

The process of the invention for preparing organically modified polysiloxanes by addition of SiH-containing polysiloxanes onto substances containing C—C multiple bonds in the presence of transition metal catalysts and of ionic liquids, so that the transition metal catalysts can be reused directly for subsequent catalysis cycles is based on the addition of ionic liquids as described above to the reaction mixture either before, during or after the hydrosilylation. The term “C—C multiple bonds” refers to double and triple carbon-carbon bonds.

Preference is given to dissolving the catalyst in an ionic liquid prior to the reaction and then adding the solution to the reactants. As catalyst, it is possible to use all hydrosilylation catalysts known from the literature. Examples of such hydrosilylation catalysts are hexachloroplatinic(IV) acid (Speyer catalyst), cis-diamminedichloroplatinum(II) (cis-Pt), di-μ-chlorodichlorobis(cyclohexene)diplatinum(II (Pt-92), tris(triphenylphosphane)rhodium(I)chloride (Rh-100). However, this selection does not constitute a restriction of the hydrosilylation catalysts which can be used.

Ionic liquids can in principle be used in all hydrosilylation reactions known from the prior art, for example as described in Walter Noll “Chemie und Technologie der Silicone”, Verlag Chemie GmbH, Weinheim/Bergstr., 1968; Bogdan Marciniec, Comprehensive Handbook on Hydrosilylation, Oxford: Pergamon Press, 1992; DE-A-21 31 741; DE-A-198 59759; DE-A-199 07814. The abovementioned patent specifications are hereby incorporated by reference for descriptions of the preferred starting materials (both the (Si—H)-functional polydimethylsiloxanes and the substances containing C—C multiple bonds) and reaction conditions.

### EXAMPLES

The following non-limiting examples illustrate the present inventive process.

General Experimental Procedure:

An (Si—H)-functional polydimethylsiloxane is heated together with 1.3 equivalents (C—C multiple bonds based on (Si—H) functions) of a compound containing a C—C multiple bond to from 50 to 160° C., preferably from 80 to 100° C. 20 ppm (metal content based on total batch size) of hydrosilylation catalyst dissolved in an ionic liquid (0.5 g per 0.02 eq of (Si—H-functional polydimethylsiloxane) are added to this mixture and the resulting mixture is stirred at preferably from 80 to 100° C. The progress of the reaction is followed by determination of the (Si—H) value. After complete (Si—H) conversion has been achieved, the reaction mixture is cooled to room temperature and the organically modified polydimethylsiloxane is filtered off from the catalyst phase or separated from the catalyst phase by simple decantation. In all cases, the chemical identity of the organically modified polydimethylsiloxane and the absence of metals in it are confirmed by ICP-OES (inductively coupled plasma optical emission spectroscopy) and NMR spectroscopy.

### Example 1

14.2 g (0.02 eq) of an α,ω-(Si—H)-polydimethylsiloxane having a total chain length of 20 Si atoms together with 14.6 g (0.026 mol) of a polyether having a mean molecular weight of 500 g/mol and a proportion of propylene glycol of 40% were heated to 90° C. 1.6 mg (20 ppm) of hexachloroplatinic(IV) acid (Speyer catalyst) dissolved in 0.5 g of 1,2,3-trimethylimidazolium methylsulfate were added to this mixture and the resulting mixture was stirred at 90° C. After 3 hours, the mixture was cooled to room temperature and the polyethersiloxane was filtered off from the catalyst phase. The polyethersiloxane was obtained as a clear, slightly yellowish liquid.

### Example 2

250 g (0.085 eq) of an α,ω-(Si—H)-polydimethylsiloxane having a total chain length of 80 Si atoms together with 62.1 g (0.11 mol) of a polyether having a mean molecular weight of 500 g/mol and a proportion of propylene glycol of 40% were heated to 90° C. 16.6 mg (20 ppm) of hexachloroplatinic(IV) acid (Speyer catalyst) dissolved in 10 g of REWOQUAT® CPEM (coconut-pentaethoxy-methylammonium methosulfate) were added to this mixture and the resulting mixture was stirred at 90° C. After 1 hour, the mixture was cooled to room temperature and the polyethersiloxane was separated off from the catalyst phase by centrifugation. The polyethersiloxane was obtained as a clear colorless liquid. 5 ppm of platinum were detected in the product.

### Example 3

14.2 g (0.02 eq) of an α,ω-(Si—H)-polydimethylsiloxane having a total chain length of 20 Si atoms together with 12.66 g (0.026 mol) of a polyether having a mean molecular weight of 400 g/mol and a proportion of propylene glycol of 100% were heated to 90° C. 4.8 mg (20 ppm) of tris(triphenylphosphane)rhodium(I) chloride (Rh 100) dissolved in 0.5 g of 1,2dimethyl-3-butylnimdazolium bromide were added to this mixture and the resulting mixture was stirred at 90° C. After 5 hours, the mixture was cooled to room temperature and the polyethersiloxane was filtered off from the catalyst phase. The polyethersiloxane was obtained as a clear colorless liquid.

### Example 4

28.4 g (0.04 eq) of an α,ω-(Si—H)-polydimethylsiloxane having a total chain length of 20 Si atoms together with 21.74 g (0.052 mol) of a polyether having a mean molecular weight of 400 g/mol and a proportion of propylene glycol of 100% were heated to 90° C. 0.8 mg (10 ppm) of cis-adminedichloroplatinum(II) (cis-Pt) dissolved in 1 g of 1,2,3-trimethylimidazolium methylsulfate were added to this mixture and the resulting mixture was stirred at 90° C. After 5 hours, the mixture was cooled to room temperature and the polyethersiloxane was filtered off from the catalyst phase. The polyethersiloxane was obtained as a clear colorless liquid.

### Example 5

28.4 g (0.04 eq) of an α,ω-(Si—H)-polydimethylsiloxane having a total chain length of 20 Si atoms together with 21.74 g (0.052 mol) of a polyether having a mean molecular weight of 400 g/mol and a proportion of propylene glycol of 100% were heated to 90° C. 1.5 mg (10 ppm) of hexachloroplatinic(IV) acid (Speyer catalyst) dissolved in 1 g of 1,2,3-trimethylimidazolium methylsulfate were added to this mixture and the resulting mixture was stirred at 90° C. After 5 hours, the mixture was cooled to room temperature and the polyethersiloxane was filtered off from the catalyst phase. The polyethersiloxane was obtained as a clear colorless liquid.

### Example 6

14.2 g (0.02 eq) of an α,ω-(Si—H)-polydimethylsiloxane having a total chain length of 20 Si atoms together with 12.66 g (0.026 mol) of a polyether having a mean molecular weight of 400 g/mol and a proportion of propylene glycol of 100% were heated to 90° C. 4.9 mg (20 ppm) of tris(triphenylphosphane)rhodium(I) chloride (Rh 100) dissolved in 0.5 g of 1,2dimethyl-3-octylimidazolium tetrafluoroborate were added to this mixture and the resulting mixture was stirred at 90° C. After 5 hours, the mixture was cooled to room temperature and the polyethersiloxane was decanted from the catalyst phase. The polyethersiloxane was obtained as a clear colorless liquid.

### Example 7

14.2 g (0.02 eq) of an α,ω-(Si—H)-polydimethylsiloxane having a total chain length of 20 Si atoms together with 12.66 g (0.026 mol) of a polyether having a mean molecular weight of 400 g/mol and a proportion of propylene glycol of 100% were heated to 90° C. 1.5 mg (20 ppm) of hexachloroplatinic(IV) acid (Speyer catalyst) dissolved in 0.5 g of 4-methyl-1-butylpyridinium tetrafluoroborate are added to this mixture and the resulting mixture was stirred at 90° C. After 1 hour, the mixture was cooled to room temperature and the polyethersiloxane was decanted from the catalyst phase. The polyethersiloxane was obtained as a clear colorless liquid.

### Example 8

14.2 g (0.02 eq) of an α,ω-(Si—H)-polydimethylsiloxane having a total chain length of 20 Si atoms together with 14.6 g (0.026 mol) of a polyether having a mean molecular weight of 500 g/mol and a proportion of propylene glycol of 40% are heated to 90° C. 5.2 mg (20 ppm) of tris(triphenylphosphane)rhodium(I) chloride (Rh 100) dissolved in 0.5 g of 3-methyl-1-butylpyridinium chloride were added to this mixture and the resulting mixture was stirred at 90° C. After 2 hours, the mixture was cooled to room temperature and the polyethersiloxane was decanted from the catalyst phase. The polyethersiloxane was obtained as a clear colorless liquid.

### Example 9

71 g (0.1 eq) of an α,ω-(Si—H)-polydimethylsiloxane having a total chain length of 20 Si atoms together with 58.7 g (0.13 mol) of a polyether having a mean molecular weight of 400 g/mol and a proportion of ethylene glycol of 100% were heated to 90° C. 5 mg (20 ppm) of di-μ-chlorodichlorobis(cyclohexene)diplatinum(II) (Pt-92) dissolved in 3 g of 1,2,3-trimethylimidazolium methylsulfate were added to this mixture and the resulting mixture was stirred at 90° C. After 5 hours, the mixture was cooled to room temperature and the polyethersiloxane was filtered off from the catalyst phase. The polyethersiloxane was obtained as a clear liquid. The recovered catalyst phase was used another five times; during these repeat experiments, no decrease in the catalyst activity can be observed and the product quality remains equally good.

### Example 10

147.1 g (0.05 eq) of an α,ω-(Si—H)-polydimethylsiloxane having a total chain length of 80 Si atoms together with 7.4 g (0.065 mol) of allyl glycidyl ether were heated to 115° C. 8 mg (20 ppm) of hexachloroplatinic(I) acid (Speyer catalyst) dissolved in 2.5 g of 1,2,3-trimethylimidazolium methylsulfate were added to this mixture and the resulting mixture was stirred at 115° C. After 3 hours, the mixture was cooled to room temperature and the epoxy-functional polydimethylsiloxane was decanted off from the catalyst phase. The epoxy-functional polydimethylsiloxane was obtained as a clear colorless liquid.

### Example 11

22.7 g (0.03 eq) of an (Si—H)-polydimethylsiloxane having a total chain length of 50 Si atoms and five lateral (Si—H) functions together with 4.5 g (0.039 mol) of allyl glycidyl ether were heated to 115° C. 1.4 mg (20 ppm) of hexachloroplatinic(IV) acid (Speyer catalyst) dissolved in 0.5 g of 1,2,3-trimethylimidazolium methylsulfate were added to this mixture and the resulting mixture was stirred at 115° C. After 3 hours, the mixture was cooled to room temperature and the epoxy-functional polydimethylsiloxane was decanted off from the catalyst phase. The epoxy-functional polydimethylsiloxane was obtained as a clear colorless liquid.

### Example 12

15.15 g (0.02 eq) of an (Si—H)-polydimethylsiloxane having a total chain length of 50 Si atoms and five lateral (Si—H) functions together with 12.6 g (0.026 mol) of a polyether having a mean molecular weight of 400 g/mol and a proportion of propylene glycol of 100% were heated to 90° C. 1.5 mg (20 ppm) of hexachloroplatinic(IV) acid (Speyer catalyst) dissolved in 0.5 g of 1,2,3-trimethylimdazolium methylsulfate were added to this mixture and the resulting mixture was stirred at 90° C. After 1 hour, the mixture was cooled to room temperature and the polyethersiloxane was decanted off from the catalyst phase. The polyethersiloxane was obtained as a clear colorless liquid.

The above description of the invention is intended to be illustrative and not limiting. Various changes or modifications in the embodiments described herein may occur to those skilled in the art. The changes can be made without departing from the scope or spirit of the invention.

1. A process for preparing organomodified polysiloxanes which comprises reacting a SiH-containing polysiloxane with a compound that contains C—C multiple bonds in the presence of transition metal catalysts, wherein
a) the reaction is carried out in the presence of an ionic liquid and
b) after the reaction is complete, the ionic liquid together with the dissolved catalyst is separated from the reaction mixture.

2. The process according to claim 1, which further comprises adding the recovered ionic liquid containing the dissolved catalyst to a reaction wherein a SiH-containing polysiloxane is reacted with a compound that contains a C—C multiple bond.

3. The process as claimed in claim 1, wherein the ionic liquid comprises at least one cation of the formulae (1) to (4):
R¹R²R³R⁴N^{⊕} (1)
R¹R²N^{⊕}═CR³R⁴ (2)
R¹R²R³R⁴P^{⊕} (3)
R¹R²P^{⊕}═CR³R⁴ (4)
where
R¹,R²,R³, R⁴ are identical or different and are each hydrogen, a linear or branched aliphatic hydrocarbon radical, a cycloaliphatic hydrocarbon radical, an aromatic hydrocarbon radical carbon atoms, an alkylaryl radical, a linear or branched aliphatic hydrocarbon radical which is interrupted by one or more hetero atoms, a linear or branched aliphatic hydrocarbon radical which has is interrupted by one or more functional groups selected from the group consisting of —O—C(O)—, —(O)C—O—, —NH—C(O—, —(O)C—NH, —(CH₃)N—C(O)—, —(O)C—N(CH₃), —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic hydrocarbon radical and is functionalized at the end of the chain by OH, NH₂, N(H)R′ where R′ is an alkyl radical, and a polyether which may have a block or random structure and has the formula —(R⁵—O)ₙR⁶,
where
R⁵ is a linear or branched hydrocarbon radical,
n is from 1 to 30 and
R⁶ is hydrogen, a linear or branched aliphatic hydrocarbon radical, a cycloaliphatic hydrocarbon radical, an aromatic hydrocarbon radical, an alkylaryl radical carbon atoms or a —C(O)—R⁷ radical where
R⁷ is a linear or branched aliphatic hydrocarbon radical atoms, a cycloaliphatic hydrocarbon radical, an aromatic hydrocarbon radical or an alkylaryl radical.

4. The process as claimed in claim 1, wherein the ionic liquid comprises at least one cation of the formulae (1) to (4):
R¹R²R³R⁴N^{⊕} (1)
R¹R²N^{⊕}═CR³R⁴ (2)
R¹R²R³R⁴P^{⊕} (3)
R¹R²P^{⊕}═CR³R⁴ (4)
where
R¹,R²,R³,R⁴ are identical or different and are each hydrogen, a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms, an alkylaryl radical having from 7 to 40 carbon atoms, a linear or branched aliphatic hydrocarbon radical which has from 2 to 20 carbon atoms and is interrupted by one or more hetero atoms selected from the group consisting of oxygen, NH, and NR′ where R′ is a C₁-C₅-alkyl radical, a linear or branched aliphatic hydrocarbon radical which has from 2 to 20 carbon atoms and is interrupted by one or more functional groups selected from the group consisting of —O—C(O)—, —(O)C—O—, —NH—C(O)—, —(O)C—NH, —(CH₃)N—C(O)—, —)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)—, a linear or branched aliphatic hydrocarbon radical which has from 1 to 20 carbon atoms and is functionalized at the end of the chain by OH, NH₂, N(H)R′ where R′ is a C₁-C₅-alkyl radical, and a polyether which may have a block or random structure and has the formula —(R⁵—O)ₙR⁶,
where
R⁵ is a linear or branched hydrocarbon radical containing from 2 to 4 carbon atoms,
n is from 1 to 30 and
R⁶ is hydrogen, a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms, an alkylaryl radical having 7 to 40 carbon atoms or a —C(O)—R⁷ radical where
R⁷ is a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms or an alkylaryl radical having from 7 to 40 carbon atoms.

5. The process as claimed in claim 1, wherein the ionic liquid comprises at least one cation which is derived from saturated or unsaturated cyclic compounds or aromatic compounds each having at least one trivalent nitrogen atom in a 4- to 10-membered heterocyclic ring in which additional heteroatoms are optionally be present and have one of the formulae (5), (6) and (7), 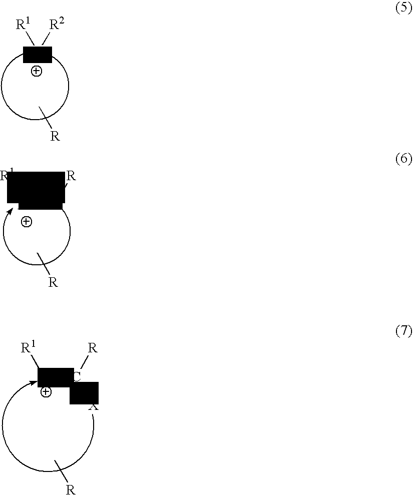
where
R¹ and R² are as defined above,
R is a hydrogen atom, a linear or branched aliphatic hydrocarbon radical, a cycloaliphatic hydrocarbon radical atoms, an aromatic hydrocarbon radical or an alkylaryl radical having from, and
X is an oxygen atom, a sulfur atom or a substituted nitrogen atom.

6. The process as claimed in claim 5, wherein the ionic liquid comprises at least one cation which is derived from saturated or unsaturated cyclic compounds or aromatic compounds each having at least one trivalent nitrogen atom in a 4- to 1 0-membered heterocyclic ring in which additional heteroatoms are optionally present and have one of the formulae (5), (6) and (7), 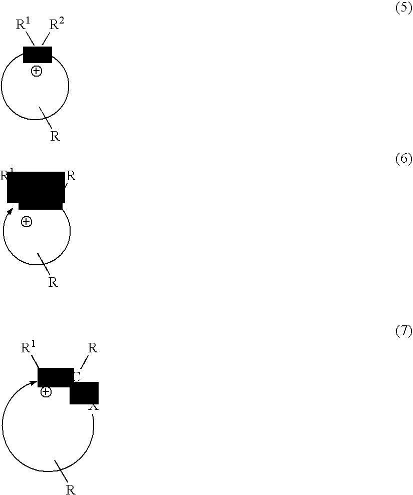
where
R¹ and R² are as defined above,
R is a hydrogen atom, a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms or an alkylaryl radical having from 7 to 40 carbon atoms, and
X is an oxygen atom, a sulfur atom or a substituted nitrogen atom NR, wherein R is defined above.

7. The process as claimed in claim 1, wherein the ionic fluid comprises at least one cation of the formula, 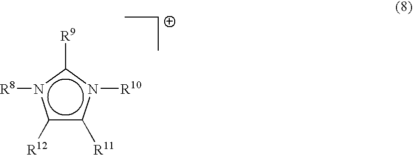
where
R⁸,R⁹,R¹⁰,R¹¹, R¹² are identical or different and are each hydrogen, a linear or branched aliphatic hydrocarbon radical, a cycloaliphatic hydrocarbon radical carbon atoms, an aromatic hydrocarbon radical, an alkylaryl radical, a linear or branched aliphatic hydrocarbon radical carbon atoms and is interrupted by one or more hetero atoms, a linear or branched aliphatic hydrocarbon radical which is interrupted by one or more functional groups selected from the group —O—C(O)—, —(O)C—O—, —NH—C(O)—, —(O)C—NH, —(CH₃)N—C(O)—, —(O)C—N(CH₃)—, —S(O₂)—O—, —O—S(O₂), —S(O₂)—NH—, —NH—S(O₂), —S(O₂)—N(CH₃)—, —N(CH₃)—S(O₂)—, a linear or branched aliphatic hydrocarbon radical which is functionalized at the end of the chain by OH, NH₂, N(H)R′ where R′ is an alkyl radical, and a polyether group, which may have a block or random structure and has the formula —(R⁵—O)ₙ—R⁶,
where
R⁵ is a hydrocarbon radical,
n is from 1 to 30 and
R¹ is hydrogen, a linear or branched aliphatic hydrocarbon radical, a cycloaliphatic hydrocarbon radical, an aromatic hydrocarbon radical, an alkylaryl radical or a —C(O)—R⁷ radical where
R⁷ is a linear or branched aliphatic hydrocarbon radical, a cycloaliphatic hydrocarbon radical, an aromatic hydrocarbon radical or an alkylaryl radical.

8. The process as claimed in claim 7, wherein the ionic fluid comprises at least one cation of the formula (8), 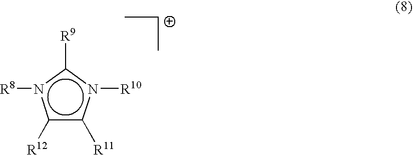
where
R⁸,R⁹,R¹⁰,R¹¹, R¹² are identical or different and are each hydrogen, a linear or branched aliphatic hydrocarbon radical having from 1 to 30 carbon atoms, a cycloaliphatic hydrocarbon radical having from 5 to 30 carbon atoms, an aromatic hydrocarbon radical having from 6 to 30 carbon atoms, an alkylaryl radical having from 7 to 40 carbon atoms, a linear or branched aliphatic hydrocarbon radical which has from 1 to 20 carbon atoms and is interrupted by one or more hetero atoms selected from the group consisting of oxygen, NH, and NR′ where R′ is a C₁-C₅-alkyl radical, a linear or branched aliphatic hydrocarbon radical which has from 1 to 20 carbon atoms and is interrupted by one or more functional groups selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂) N(CH₃)—, —N(CH₃)—S(O₂)—, a linear or branched aliphatic hydrocarbon radical which has from 1 to 20 carbon atoms and is functionalized at the end of the chain by OH, NH₂, N(H)R′ where R′ is a C₁-C₅-alkyl radical, and a polyether which may have a block or random structure and has the formula —(R⁵—O)ₙ—R⁶,
where
R⁵ is a hydrocarbon radical containing from 2 to 4 carbon atoms,
n is from 1 to 30 and
R⁶ is hydrogen, a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms, an alkylaryl radical having 7 to 40 carbon atoms or a —C(O)—R⁷ radical where
R⁷ is a linear or branched aliphatic hydrocarbon radical having from 1 to 20 carbon atoms, a cycloaliphatic hydrocarbon radical having from 5 to 30 carbon atoms, an aromatic hydrocarbon radical having from 6 to 30 carbon atoms or an alkylaryl radical having from 7 to 40 carbon atoms.

9. The process as claimed in claim 1, wherein the ionic liquid comprises an anion selected from the group consisting of halides, bis(perfluoroalkylsulfonyl)amides, alkyltosylates and aryltosylates, perfluoroalkyltosylates, nitrates, sulfates, hydrogensulfates, alkylsulfates and arylsulfates, perfluoroalkylsulfates, sulfonates, alkylsulfonates and arylsulfonates, perfluorinated alkylsulfonates and arylsulfonates, alkylcarboxylates and arylcarboxylates, perfluoroalkylcarboxylates, perchlorates, tetrachloroaluminates, saccharinates, dicyanamide, tetrafluoroborate, hexafluorophosphate and phosphate.

10. A process as claimed in claim 1, wherein the ionic liquid comprises a cation selected from the group consisting of imidazolium ions substituted in the 2-position, together with methylsulfate as anion.

11. The process according to claim 10, wherein the imidazolium ion is 1,2,3-trimethylimidazolium.

12. The process as claimed in claim 1, wherein the ionic liquid comprises a cation selected from the group consisting of pyridinium ions together with tetrafluoroborate as anion.

13. The process as claimed in claim 1, wherein the ionic liquid comprises a mixture of two or more cations.

14. The process as claimed in claim 1, wherein the amount of ionic liquid present in the process is from about 0.1 to about 98% by weight, based upon the heterogeneous reaction mixture.

15. The process as claimed in claim 1, wherein the amount of ionic liquid present in the process is from about 0.1 to about 20% by weight, based upon the heterogeneous reaction mixture.

16. The process according to claim 1, wherein the amount of ionic liquid present in the process is from about 0.5 to about 5% by weight, based upon the heterogeneous reaction mixture.
